(19) United States
(12) Patent Application Publication
(10) Pub. No.: US 2022/0097152 A1
(43) Pub. Date: Mar. 31, 2022

(54) HANDHELD WORK APPARATUS AND METHOD FOR OPERATING A HANDHELD WORK APPARATUS

(71) Applicant: Andreas Stihl AG & Co. KG, Waiblingen (DE)

(72) Inventors: Tobias Aupperle, Berglen (DE); Johannes Gueltlinger, Stuttgart (DE); Roland Mandel, Stuttgart (DE); Felix Mayer, Waiblingen (DE)

(21) Appl. No.: 17/486,413

(22) Filed: Sep. 27, 2021

(30) Foreign Application Priority Data
Sep. 25, 2020 (EP) 20 198 401.0

(51) Int. Cl. B23D 45/16

(52) U.S. Cl. CPC B23D 45/16; B23D 47/12

(57) ABSTRACT

The disclosure relates to a handheld work apparatus having a drive motor, wherein the drive motor drives at least one tool. The work apparatus includes a mechanical braking device for the tool, wherein the braking device can be adjusted between a braked position and a released position by the operator via an actuating lever. The work apparatus includes an electromagnet and an armature cooperating with the electromagnet. The electromagnet is configured to hold the braking device in its released position. The work apparatus has at least one control device. The at least one control device is configured to ascertain the position of the armature with respect to the electromagnet to determine the position of the braking device.

### CROSS REFERENCE TO RELATED APPLICATION

This application claims priority of European patent application no. 20 198 401.0, filed Sep. 25, 2020, the entire content of which is incorporated herein by reference.

### TECHNICAL FIELD

The disclosure relates to a handheld work apparatus and a method for operating a handheld work apparatus.

### BACKGROUND

Cutoff machines having a drive motor and having a tool are known, wherein the tool is driven via a belt drive. Cutoff machines of this type are complex work apparatuses which are subject to regular maintenance intervals. The work apparatus can be put into a service state, in which service routines are carried out. Here, the exchange of information between the work apparatus and the operator is also necessary.

### SUMMARY

It is an object of disclosure to provide a handheld work apparatus wherein transmission of information between operator and work apparatus in a straightforward manner is made possible.

The aforementioned object can, for example, be achieved by a handheld work apparatus including: a tool; a drive motor configured to drive the tool; a mechanical braking device for the tool; an actuating lever; the braking device being configured to be adjusted between a braked position and a released position by an operator via the actuating lever; an electromagnet; an armature configured to cooperate with the electromagnet; the electromagnet being configured to hold the braking device in the released position; and, a control device configured to ascertain a position of the armature with respect to the electromagnet so as to determine a position of the braking device.

A work apparatus according to the disclosure includes a drive motor, wherein the drive motor drives at least one tool. The work apparatus has a mechanical braking device for the tool, wherein the braking device can be adjusted between a braked position and a released position by the operator via an operating element. The work apparatus includes an electromagnet and an armature cooperating with the electromagnet. The electromagnet is configured to hold the braking device in its released position. The work apparatus has at least one control device, wherein the at least one control device is configured to ascertain the position of the armature with respect to the electromagnet to determine the position of the braking device. In the released position of the braking device, the drive motor can drive the tool. In the braked position, the drive of the tool via the drive motor is prevented by the braking device.

If the operator actuates the operating element, the armature is moved relative to the electromagnet, wherein the control device detects the position of the armature, in particular in the released position and the braked position of the braking device.

By using specific operating patterns, the operator can thus transmit information to the work apparatus, wherein the control device determines the position of the armature, analyzes the operating pattern and processes the transmitted information. Thus, for example, a service state can be acknowledged without having to provide additional sensors or user interfaces on the work apparatus.

Provision can advantageously be made for the mechanical braking device to include a brake band, wherein the brake band acts on a clutch drum driving the tool. The clutch drum is part of a centrifugal clutch.

Preferably, the operating element mechanically actuates a lever, wherein in particular the armature is arranged on the lever. Advantageously, a spring unit acts on the lever in such a way that the armature is tensioned via a tensile force in the direction away from a yoke of the electromagnet. When the operating element is actuated, the armature is guided onto the electromagnet via the lever, counter to the tensile force. If the operator releases the lever with the electromagnet inactive, the lever will pull the armature away from the electromagnet via the tensile force of the spring unit. The electromagnet is in particular configured in such a way that when the electromagnet is energized in the released position of the braking device, the armature is held on the yoke of the electromagnet, counter to the tensile force. If the electromagnet is not energized, the armature is drawn away from the electromagnet via the lever via the tensile force, by which means the braking device brakes the clutch drum and therefore also the tool.

Provision is advantageously made for the position of the armature with respect to the electromagnet to be determined by a test voltage being applied to the electromagnet and the resultant current flow being ascertained. Depending on the position of the armature with respect to the electromagnet, the inductance of the coil of the electromagnet also changes. If the armature is resting on the electromagnet, the inductance is higher than when the yoke of the electromagnet is open. As the inductance increases, the current intensity measured on the coil of the electromagnet reacts to the voltage signal with an increased delay. Conclusions about the position of the armature can be drawn by the control device on the basis of the measured current intensities.

The test voltage is in particular configured in such a way that the magnetic force of the electromagnet which results from the test voltage is lower than the tensile force acting on the armature. Accordingly, the test voltage is sufficiently low that when the test voltage is applied the armature cannot be held on the electromagnet. As a result, the test voltage has no influence on the position of the braking device. The test voltage can preferably correspond to individual voltage pulses. As a result, simple evaluation of the current intensity is possible.

Provision can preferably be made for the position of the armature with respect to the electromagnet to be ascertained by a signal from an additional sensor or an electronic switch being evaluated.

It is a further object of the disclosure to provide a method for operating a handheld work apparatus which permits transmission of information between operator and work apparatus in a straightforward manner.

The aforementioned further object can, for example, be achieved by a method for operating a handheld work apparatus, wherein the work apparatus includes a tool, a drive motor configured to drive the tool, a mechanical braking device for the tool, wherein the braking device is configured to be adjusted between a braked position and a released position by an operator via an actuating lever, the work apparatus further includes a control device and an electromagnet configured to hold the braking device in the released position. The method includes: repeatedly ascertaining whether the braking device is in the braked position or in the released position through a position of the armature with respect to the electromagnet over a period of time.

According to a method according to the disclosure, the control device ascertains the position of the braking device through the position of the armature with respect to the electromagnet repeatedly over a predetermined time period. As a result, it is possible to detect specific operating patterns, which are used for the transmission of information.

Provision can preferably be made for the control device to apply test voltage pulses and to ascertain the resultant current flow on the electromagnet. The current flow or the current intensity varies as a function of the position of the armature relative to the electromagnet because of the variable induction. The current flow through the electromagnet rises over a certain time period, in a manner braked by the inductance. If the inductance is increased, for example by the armature resting on the electromagnet, the rise of the current flow is slowed, as a result of which the maximum current value over the corresponding time period is likewise reduced. As the inductance becomes lower, for example as a result of a remote position of the armature, the rise in the current flow takes place more quickly, and therefore the maximum current value over the corresponding time period increases.

Preferably, to ascertain the position of the braking device, the control device compares the current flow with reference values. Preferably, the control device can ascertain the reference values in the braked position of the braking device. In the braked position of the braking device, the distance between the armature and the yoke of the electromagnet is at a maximum, as a result of which the inductance is at a minimum. When setting up the reference value in the braked position, the current flow reaches a global maximum current value because of the reduced inductance. The subsequently measured current intensities are compared with the reference values, by which means the position of the armature and therefore the position of the braking device are determined.

Provision is advantageously made for the control device to ascertain a pattern of the actuation of the operating element. Via such patterns, a multiplicity of items of information can be transmitted. Preferably, the control device compares the detected pattern of the actuation of the operating element with a stored pattern. Depending on the stored pattern, further method steps which influence the state or the further operation of the work apparatus can be initiated. The control device in particular changes the state of at least one component of the work apparatus when the detected pattern matches the stored pattern.

A pattern can, for example, consist of multiple attempts of the operator to attempt to move the braking device into the braked position in a predefined time period.

### BRIEF DESCRIPTION OF THE DRAWINGS

The invention will now be described with reference to the drawings wherein:

FIG. 1 shows a partly sectional side view of a cutoff machine, the section plane being located in the outrigger;

FIG. 2 shows a schematic sectional illustration through the drive of the cutoff machine from FIG. 1;

FIG. 3 shows a plan view of the cutoff machine from FIG. 1 in the direction of the arrow III in FIG. 1;

FIG. 4 shows an enlarged illustration of the region of the outrigger of the cutoff machine from FIG. 1 that is illustrated in section;

FIG. 5 shows a side view of the outrigger and the protective hood, wherein some components of the outrigger are not illustrated;

FIG. 6 shows an enlarged illustration in the manner of an extract of the region of the pivoting lever from FIG. 5 with the pivoting lever in the released position;

FIG. 7 shows a schematic flowchart of a method according to the disclosure for determining the position of the armature;

FIG. 8 shows a schematic graph of the voltage pulses and the current curve over time; and,

FIG. 9 shows an enlarged illustration in the manner of an extract of the region of the pivoting lever with a schematically illustrated additional positioning unit.

### DESCRIPTION OF THE PREFERRED EMBODIMENTS

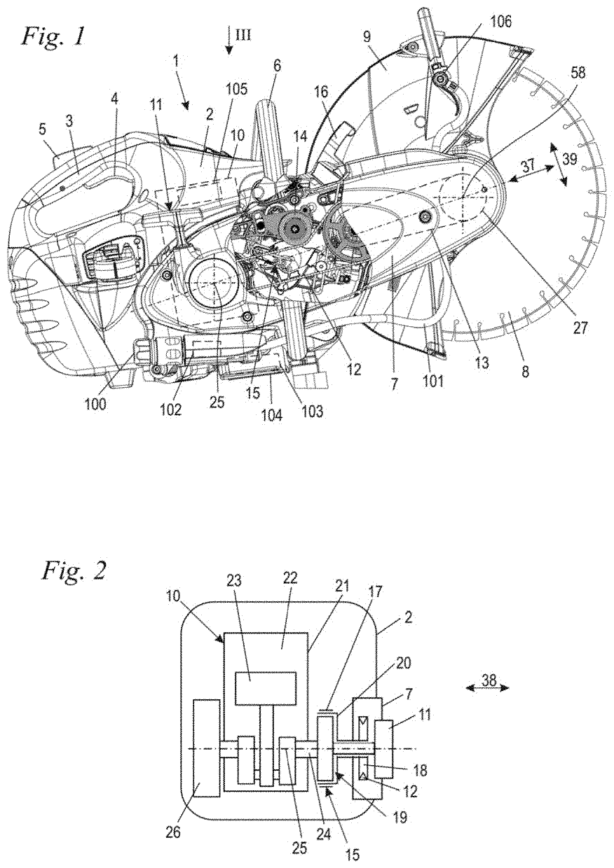

FIG. 1 shows a cutoff machine 1 as an embodiment of a handheld work apparatus. The cutoff machine 1 has a housing 2, to which a handle 3 and a bow handle 6 for guiding the cutoff machine 1 during operation are secured. Provided on the handle 3 which, in the embodiment, is arranged on the top side of the housing 2, are a throttle lever 4 and a throttle lock 5 for operating a drive motor 10 arranged in the housing 2. The handle 3 can also be implemented as a rear handle. The drive motor 10 is preferably an internal combustion engine, in particular a single-cylinder two-stroke engine. To start the drive motor 1 manually, a starting device 11, a pull-cord starter in the embodiment, is provided. It is also possible to provide for the drive motor 10 to be an electric motor, which is preferably supplied with power via a rechargeable battery.

The cutoff machine 1 has an outrigger 7 which, in the embodiment, is fixed to the housing 2. At the free end of the outrigger 7, a cutting disk 8 is supported such that it can rotate about a rotational axis 58. The cutting disk 8 is the tool of the cutoff machine 1 and is driven by the drive motor 10 via a belt drive. Another drive of the cutting disk 8 may also be advantageous. The belt drive is implemented as a two-stage belt drive in the embodiment and includes a first drive belt 12 and a second drive belt 13. To tension the drive belts 12 and 13, tension rollers 14 are provided, one of which is shown in FIG. 1. The belt drive is configured as a step-down gear mechanism, so that the rotational speed of the cutting disk 8 is lower than that of the drive motor 10. Provision can also be made for the cutoff machine 1 to have only one drive belt between the drive motor 10 and the driven tool 8.

The cutting disk 8 is covered over part of its circumference by a protective hood 9. During operation, when the cutting disk 8 is used for cutting rock, a large quantity of dust arises. In order to bind the dust and to cool the cutting disk 8, a liquid supply, in particular a water supply, can be provided. The liquid supply includes a liquid connector 100 to be connected to an external liquid feed. The liquid connector 100 is connected via a liquid line 101 to at least one feed valve 106, in particular a feed nozzle, on the protective hood 9. To control the quantity of liquid supplied, a valve 102, which is electrically controlled, is provided. The quantity of liquid to be supplied which is desired by the operator can be set via an operating panel 107 (FIG. 3) on the upper side of the housing 2. In an alternative embodiment, it may be expedient to configure the cutoff machine 1 with a manually adjustable or without a liquid supply.

A control device 103 for the valve 102, which activates the valve 102 appropriately, is provided. In the embodiment, the control device 103 is arranged on the underside of the housing 2. In the embodiment, the control device 103 is not arranged in the housing 2 but outside the housing 2 and is covered at the bottom by a separate cover 104. The control device 103 is advantageously potted, so that via the potting and the cover 104, the result is dual protection against contaminants or liquid.

The cover 104 is fixed to the housing 2, advantageously via snap-in connections and/or screw connections. The control device 103 is advantageously located at a distance in the cover 104. A defined distance between the control device 103 and the cover 104 can be achieved, for example, via ribs between the control device 103 and the cover 104. In a preferred configuration, the cover 104 has at least one outlet opening on its underside, which is arranged on the bottom thereof in normal operation, so that moisture or dirt can escape from the cover 104. It may be advantageous to support the control device 103 with respect to the cover 104 via at least one damping element.

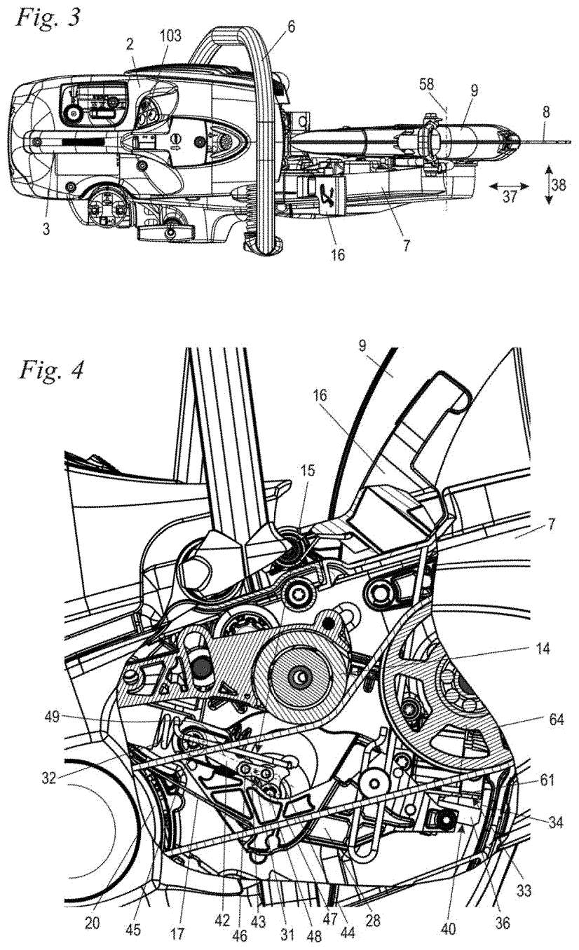

To control the drive motor 10, an additional control device 105 is advantageously provided, which is configured separately from the control device 103 and in particular is arranged in the upper region of the housing 2 on the drive motor 10 itself. Another arrangement of the additional control device 105 or the arrangement of a further control device for activating the drive motor 10 may also be advantageous. The control of the electromagnet 33 (FIG. 4) can advantageously be carried out in the additional control device 105.

The cutoff machine 1 has a braking device 15. To trigger the braking device 15, a rate of rotation sensor is advantageously provided. In the embodiment, provision is made for the rate of rotation sensor likewise to be arranged in the control device 103. The rate of rotation sensor is advantageously aimed at the rotational axis 58 of the cutting disk 8. An axis of measurement of the rate of rotation sensor is preferably located parallel to the rotational axis 58.

The outrigger 7 has a longitudinal direction 37 which, in the embodiment, forms the straight connecting line between the drive axis and the output axis of the belt drive in a side view in the direction of the drive axis. In the embodiment, the drive axis coincides with a rotational axis 25 of a crankshaft 24 (FIG. 2) of the drive motor 10, and the output axis is the rotational axis 58 of the cutting disk 8. In the longitudinal direction 37, the greatest extent of the outrigger 7 is located at right angles to the rotational axis 58. The outrigger 7 has a vertical direction 39, which is aligned at right angles to the longitudinal direction 37 and at right angles to the rotational axes 25 and 58. The outrigger 7 additionally has a transverse direction 38 which, in FIG. 1, is aligned at right angles to the plane of the page and is shown in FIG. 2. The transverse direction 38 extends at right angles to the longitudinal direction 37 and at right angles to the vertical direction 39.

FIG. 2 shows the schematic structure of the drive of the cutoff machine 1 in detail. The drive motor 10 has a cylinder 21, in which a combustion chamber 22 is formed. The combustion chamber 22 is delimited by a piston 23, which drives the crankshaft 24 in rotation about the rotational axis 25. A fan wheel 26 for delivering cooling air is arranged on one side of the drive motor 10. In the embodiment, a centrifugal clutch 19, via which the crankshaft 24 is to be connected to a drive disk 18 of the belt drive, is arranged on the opposite side. The centrifugal clutch 19 has a clutch drum 20, on the outer circumference of which there is arranged a brake band 17 of the braking device 15. The braking device 15 acts on the clutch drum 20 of the centrifugal clutch 19, that is, on the output side of the centrifugal clutch 19. The starting device 11 is arranged on the outside of the outrigger 7.

As FIG. 1 shows, an actuating lever 16 is arranged on the upper side of the outrigger 7, being used to release the braking device 15, as will be described in more detail below.

The arrangement of the actuating lever 16 is also shown in FIG. 3. FIG. 3 also shows the alignment of the transverse direction 38 at right angles to the longitudinal direction 37.

FIG. 4 shows the configuration of the braking device 15 in more detail. The braking device 15 has a pivoting lever 28. The pivoting lever 28 forms the actuating element of the braking device 15. FIG. 4 shows the pivoting lever 28 in a released position 40 of the braking device 15. The braking device 15 includes an electromagnet 33, which is fixed to the outrigger 7. Arranged on the pivoting lever 28, adjacent to the free end of the pivoting lever 28, is an armature 36 which, in the released position 40, rests on the electromagnet 33 and is fixed to the electromagnet 33 by the magnetic force. The pivoting lever 28 is held in the released position 40 by the electromagnet 33. In the released position 40, the brake band 17 is released and does not rest firmly on the circumference of the clutch drum 20. As a result, the drive motor 10 can drive the cutting disk 8 (FIG. 1) via the belt drive when the centrifugal clutch 19 (FIG. 2) engages.

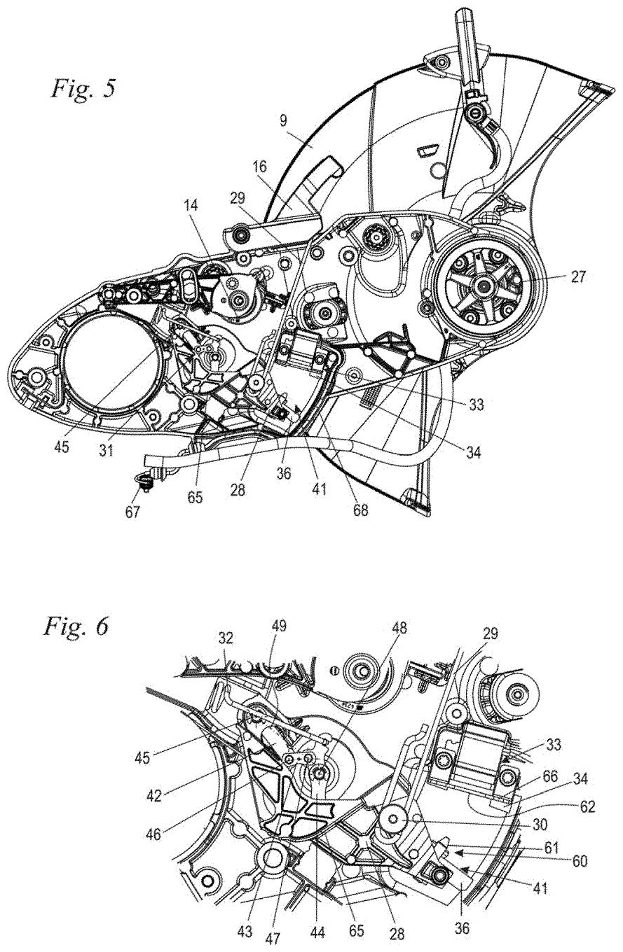

The braking device 15 advantageously has a toggle lever arrangement 31, which acts on the brake band 17. When the pivoting lever 28 is pivoted out of the released position 40, shown in FIG. 4, into the braked position 41, shown in FIG. 5, the toggle lever arrangement 31 is used to pull the brake band 17 around the clutch drum 20 and, as a result, to brake the cutting disk 8. As FIG. 4 shows, the toggle lever arrangement 31 includes a lever 44, which is held on the connecting piece pivotably about a pivot axis 48. On the lever 44, a trigger spring 32 is hooked in at one end. At a second end of the lever 44, hidden by the pivoting lever 28 in FIG. 4, the brake band 17 is hooked in by one end. The second end of the brake band 17 is fixed firmly to the housing. In order to pull the brake band 17 firmly around the clutch drum 20, the lever 44 in the illustration in FIG. 4 must pivot about the pivot axis 48 in the counterclockwise direction. On the lever 44, between the pivot axis 48 and the hook-in point of the trigger spring 32, a lever 43 is pivotably mounted about a pivot axis 47. At the second end of the lever 43, a lever 42 is pivotably mounted about a pivot axis 56. The lever 42 is pivotably mounted by its other end about a pivot axis 45 and is guided in its movement by the pivoting lever 28. In the embodiment, the pivot axis 45 is the pivot axis about which the pivoting lever 28 is pivotably mounted with respect to the outrigger 7. However, provision can also be made for the lever 42 to be pivotably mounted with respect to the pivoting lever 28 about a pivot axis at a distance from the pivot axis 45. The pivot axes 45, 46, 47 and 48 are located parallel to one another. The pivot axes 45 and 47 define a toggle lever plane 49. The pivot axis 46 which forms the toggle lever joint is located between the pivot axes 45 and 47. In the released position 40, the pivot axis 46 is located at a short distance from the toggle lever plane 49. In FIG. 4, it is also possible to see an intermediate disk 64 of the belt drive, around which the first drive belt 12 is guided.

To actuate the braking device 15, the electromagnet 33 is switched off. As a result, the armature 36 is released from the electromagnet 33, and the pivoting lever 28 pivots into the braked position 41 shown in FIGS. 5 and 6. In the released position 40 of the braking device 15, the toggle lever arrangement 31 is pre-tensioned, as FIG. 4 shows. Since the pivot axis 46, at which the levers 42 and 43 are connected to each other, and the hook-in point of the trigger spring 32 on the lever 44 are located on opposite sides of the toggle lever plane 49, the force of the trigger spring 32 acts in the direction of a displacement of the toggle lever arrangement 31 in the direction of the braked position 41. This force acts counter to the electromagnet 33 in the released position 40. In the released position 40, the transmission angle of the spring force to the toggle lever is reduced because of the virtually extended toggle lever joint, which is formed on the axis 46, in such a way that the magnetic force of the electromagnet 33 is sufficient to keep the pivoting lever 28 in the kinematically unstable released position 40, counter to the active spring tension of the trigger spring 32. The electromagnet 33 can hold the braking device 15 in the released position 40 of the braking device 15.

If the electromagnet 33 is switched off, then the trigger spring 32 displaces the lever 44. In the process, the pivot axis 46 moves further away from the toggle lever plane 49. The toggle lever joint toggles, and the trigger spring 32 is able to pivot the lever 44, as a result of which the brake band 17 is tensioned. In the braked position 41 of the braking device 15, the pivot axis 46 and the hook-in point of the trigger spring 32 on the lever 44 are also located on opposite sides of the toggle lever plane 49. In the embodiment, irrespective of the position of the braking device 15, the pivot axis 46 is always located on one side, below the toggle lever plane 49 in the illustration in FIG. 4. As a result, the toggle lever arrangement 31 does not act in a self-locking manner, that is, the toggle lever joint is preferably never forced over onto the opposite side of the toggle lever plane 49. No return spring which unlocks the toggle lever arrangement 31 is needed. In the released position 40 of the pivoting lever 28, the toggle lever arrangement 31 is advantageously held in its unstable position exclusively by the electromagnet 33.

The output disk 27 of the belt drive is also shown in FIG. 5.

To displace the braking device 15 from the braked position 41 of the pivoting lever 28, shown in FIGS. 5 and 6, in which the brake band 17 is tightened around the clutch drum 20, into the released position 40 shown in FIG. 4, in which the brake does not act on the clutch drum 20, the operator preferably pivots the actuating lever 16 upward. An actuation rod 29, also shown in FIG. 6, is hooked into the actuating lever 16 (FIG. 5). The actuation rod 29 is hooked into a guide pin 30 of the pivoting lever 28 and pivots the pivoting lever 28 into the released position 40. The actuation rod 29 is hooked into the guide pin 30 with a slot, so that the actuating lever 16 moves with respect to the pivoting lever 28 and can be reset to its initial position without the braking device 15 being reset to the braked position 41 of the pivoting lever 28.

As shown in FIG. 6, a guide 60 is provided. The guide 60 includes a lug 61 which projects through an opening 62 in a sheet metal guide 66. The sheet metal guide 66 is configured in an L shape in the embodiment and fixed to the electromagnet 33. The opening 62 and the lug 61 limit the relative movement of the electromagnet 33 with respect to the armature 36 in the transverse direction 38. Via the guide 60, the armature 36 and electromagnet 33 are also positioned relative to each other even when there are increased vibrations of the cutoff machine 1. In FIG. 4 the armature 36 is resting on the yoke 34 of the electromagnet 33 and is held by the latter. The lug 61 projects into the opening 62.

As FIG. 5 also shows, the electromagnet 33 is connected via an electrical line 68 to a connecting plug 67 to be connected to a control device. The control device is preferably the control device 103 which also has the rate of rotation sensor, so that the electromagnet 33 can be released if the rate of rotation of the cutoff machine 1 exceeds a predefined value.

The control device 103 is configured in such a way that it is able to ascertain the position of the armature 36 with respect to the electromagnet 33 to determine the position of the braking device 15.

Provision can advantageously be made for the additional control device 105 to be configured in such a way that it is able to ascertain the position of the armature 36 with respect to the electromagnet 33 to determine the position of the braking device 15.

In addition, the control device 103 is advantageously configured in such a way that transmission of information between the operator and the work apparatus in a straightforward manner is possible. Such a transmission of information is important in particular when the work apparatus is in a service state. In such a state, the operator can, for example, be requested to replace or to service certain components. The operator must then confirm the procedure carried out.

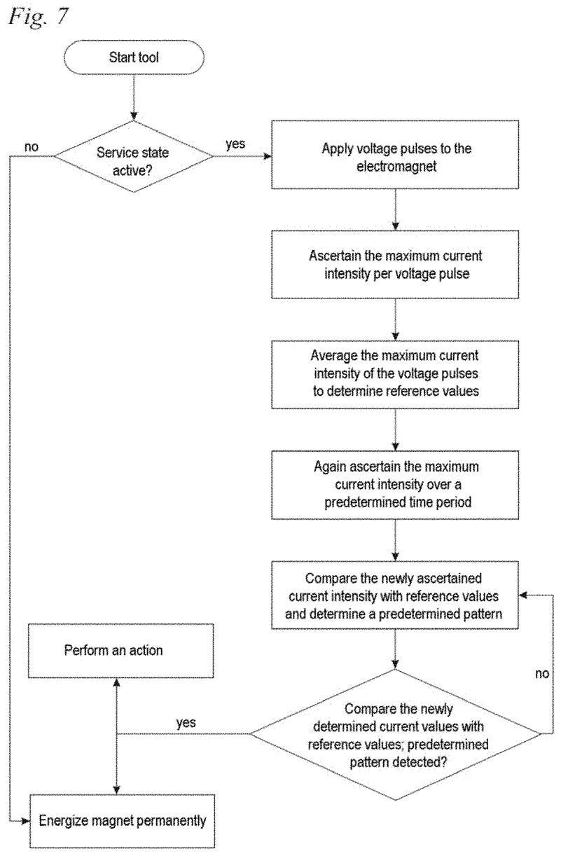

In the embodiment, the operator can input operating patterns 50 via the actuating lever 16. For this purpose, the control device 103 detects the position of the armature 36 with respect to the electromagnet 33. As already explained above, the armature 36 is mechanically coupled with the pivoting lever 28. Ascertaining the position of the armature 36 is described in more detail below with reference to the flowchart shown in FIG. 7.

After the work apparatus has been started up, the control device 103, 105 checks whether the service state has been activated. The service state can be triggered, for example, depending on a minimum number of operating hours, on ventilation processes of the braking device 15 or the like since a previous maintenance interval. If the service state is deactivated, the normal operation of the work apparatus 1 continues. If the service state has been activated, the determination of the position of the armature 36 and therefore also the determination of the position of the braking device 15 are carried out.

In order to be able to determine the position of the armature 36 with respect to the electromagnet 33, the control device carries out current intensity measurements on the coil of the electromagnet 33, wherein the current intensity is different as a result of the induction changing as a function of the position of the armature 36. The inductance causes a braking action on the current flow through the electromagnet 33. If the inductance is high, the current values rise only slowly because of the braking action on the current flow. If the inductance is low, the current values rise correspondingly quickly.

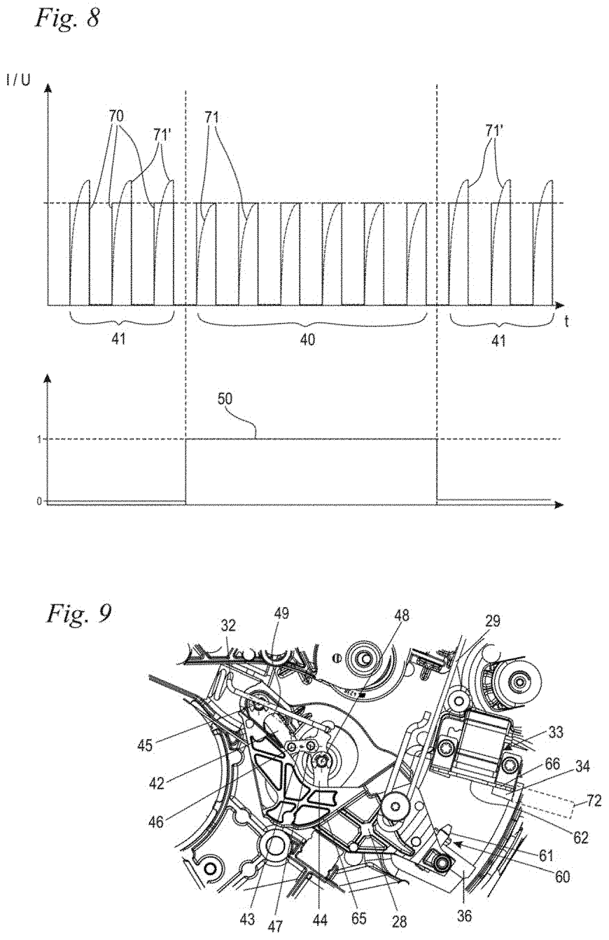

As shown in FIG. 8, the control device 103, 105 outputs voltage pulses 70 to the electromagnet 33 in order to be able to detect the position of the armature 36. The voltage pulses 70 are time-limited. Over the period of the voltage pulse 70, the current curve 71, 71′ rises until the voltage pulse is terminated. If the armature 36 is resting on the electromagnet 33, the inductance is increased, which means that the current flow is braked. Consequently, the current values rise more slowly, as a result of which the maximum current value within a voltage pulse 70 is lower. If the armature 36 is at a distance from the electromagnet 33, the inductance is reduced, as a result of which the current flow is braked less intensely. The current values rise more quickly, as a result of which higher maximum current values are achieved within a voltage pulse. In order therefore to ascertain the position in which the braking device is located, reference values are ascertained in a first step. The control device 103 outputs voltage pulses 70, which preferably have a rectangular form according to FIG. 8, to the coil of the electromagnet 36. The voltage pulses 70 are configured in such a way that the holding force produced by the electromagnet 33 is not sufficient to hold the armature 36 on the electromagnet 33 counter to the tensile force of the trigger spring 32. The braking device 15 is consequently in the braked position 41 as long as the operator does not actuate the actuating lever 16. In this braked position 41, the distance between the armature 36 and the yoke 34 of the electromagnet 33 is at a maximum. Consequently, the induction is at a minimum, as a result of which increased current values can be measured within a voltage pulse 70. To form a reference value, a plurality of maximum values of the current curve 71 are averaged. Such maximum values of the current curve 71 in the braked position 41 of the braking device 15 preferably lie at around 50 mA.

Once the control device 103 has ascertained the reference values, further current curves 71′ as a response to the voltage pulses 70 are measured. If, in the service state, the actuating lever 16 is actuated by the operator, the braking device 15 is in the released position 40. In this released position 40, the distance between the armature 36 and the yoke 34 of the electromagnet 33 is at a minimum. The armature 36 preferably lies directly on the yoke 34. Consequently, the induction is at a maximum, as a result of which the current flow is braked and only low current values are produced within the voltage pulse 70. Such current values in the released position 40 of the braking device 15 preferably lie at around 35 mA. The control device 103, 105 compares the ascertained current values with the previously determined reference values and detects whether the distance between the armature 36 and the electromagnet 33 is large or small or whether the braking device 15 is in the fixed position 41 or in the released position 40.

Of course, the control device 103, 105 provides appropriate tolerances during the determination of the position of the armature 36. Thus, a released position 40 of the braking device 15 is assumed even if there is a deviation of the current curve 71 of less than 20%, in particular of less than 10%, as compared with the expected reference value.

Stored in the control device 103, 105 are operating patterns 50, which take into account a dependence of time period and number of switching operations of the braking device 15 with the operating lever 16 from the braked position 41 into the released position 40 and back again. Depending on the operating pattern 50, a corresponding item of information can be transmitted from the operator to the work apparatus 1. The control device 103, 105 compares the previously stored operating pattern 50 with the operating patterns 50 carried out by the operator and measured by the control device 103. Depending on the operating pattern 50 detected, a procedure is triggered which, for example, acts on the state of a component of the work apparatus 1 and changes the latter. The service state is finally ended. The work apparatus 1 is again in the operating state.

In an alternative embodiment of the work apparatus 1, it may be expedient to provide an additional positioning unit 72 which determines the position of the armature 36. Such a positioning unit 72 is illustrated schematically in FIG. 9. The positioning unit 72 is connected to the control device 103, 105. The positioning unit 72 cooperates with the armature, the position of the armature 36 or the position of the braking device 15 being detected via the control device 103, 105. It may be expedient to configure the positioning unit 72 as a switch. When the switch is actuated by the armature 33, a circuit is either interrupted or completed, as a result of which the control device 103, 105 detects the position of the armature 33. It may also be advantageous to configure the positioning unit 72 as a non-contact switch which, in interaction with the armature 33, conducts a corresponding signal to the control device 103, 105. A switch of this type can be configured, for example, as a proximity sensor, Hall sensor, reed contact.

It is understood that the foregoing description is that of the preferred embodiments of the invention and that various changes and modifications may be made thereto without departing from the spirit and scope of the invention as defined in the appended claims.

What is claimed is:

1. A handheld work apparatus comprising:
a tool;
a drive motor configured to drive said tool;
a mechanical braking device for said tool;
an actuating lever;
said braking device being configured to be adjusted between a braked position and a released position by an operator via said actuating lever;
an electromagnet;
an armature configured to cooperate with said electromagnet;
said electromagnet being configured to hold said braking device in said released position; and,
a control device configured to ascertain a position of said armature with respect to said electromagnet so as to determine a position of said braking device.

2. The handheld work apparatus of claim 1, wherein said mechanical braking device includes a brake band configured to act on a clutch drum driving said tool.

3. The handheld work apparatus of claim 1 further comprising:
a pivoting lever;
said actuating lever being configured to mechanically actuate said pivoting lever; and,
said armature being arranged on said pivoting lever.

4. The handheld work apparatus of claim 3 further comprising:
a trigger spring configured to act on said pivoting lever in such a way that said armature is tensioned via a tensile force in a direction away from a yoke of said electromagnet.

5. The handheld work apparatus of claim 3, wherein said electromagnet is configured such that when said electromagnet is energized in said released position of said braking device, said armature is held on a yoke of said electromagnet, counter to a tensile force.

6. The handheld work apparatus of claim 1, wherein the position of said armature with respect to said electromagnet is ascertained by a test voltage being applied to said electromagnet and a resultant current flow being ascertained.

7. The handheld work apparatus of claim 6, wherein the test voltage is configured such that a magnetic force of said electromagnet which results from the test voltage is lower than a tensile force acting on said armature.

8. The handheld work apparatus of claim 6, wherein the test voltage corresponds to individual voltage pulses.

9. The handheld work apparatus of claim 1 further comprising an additional positioning unit, wherein a position of said armature with respect to said electromagnet is ascertained by a signal from said additional positioning unit being evaluated.

10. The handheld work apparatus of claim 1 further comprising:
an additional positioning unit configured to output a signal; and,
said control device being configured to determine a position of said armature with respect to said electromagnet by evaluating said signal from said additional positioning unit.

11. A method for operating a handheld work apparatus, wherein the work apparatus includes a tool, a drive motor configured to drive the tool, a mechanical braking device for the tool, wherein the braking device is configured to be adjusted between a braked position and a released position by an operator via an actuating lever, the work apparatus further includes a control device and an electromagnet configured to hold the braking device in the released position, the method comprising:
repeatedly ascertaining whether the braking device is in the braked position or in the released position through a position of the armature with respect to the electromagnet over a period of time.

12. The method of claim 11, wherein the control device applies test voltage pulses and ascertains a resultant current flow on the electromagnet.

13. The method of claim 12, wherein the control device compares the resultant current flow with reference values to ascertain whether the braking device is in the braked position or in the released position.

14. The method of claim 13, wherein the control device is configured to ascertain the reference values in the braked position of the braking device.

15. The method of claim 11 further comprising ascertaining a pattern of actuation of the actuating lever via the control device.

16. The method of claim 15 further comprising comparing the detected pattern of the actuation of the actuating lever with a stored pattern via the control device.

17. The method of claim 15 further comprising changing, via the control device, a state of at least one component of the work apparatus when the detected pattern matches the stored pattern.
